(19) United States
(12) Patent Application Publication
(10) Pub. No.: US 2022/0190633 A1
(43) Pub. Date: Jun. 16, 2022

(54) MODULAR POWER SUPPLY APPARATUS

(71) Applicant: VARTA Microbattery GmbH, Ellwangen Jagst (DE)

(72) Inventors: Martin Elmer, Ellwangen (DE); Florian Ermer, Heidenheim (DE)

(21) Appl. No.: 17/442,717

(22) PCT Filed: Mar. 10, 2020
(86) PCT No.: PCT/EP2020/056395

§ 371 Date: Sep. 24, 2021

(30) Foreign Application Priority Data
Mar. 25, 2019 (EP) 19164976.3

(51) Int. Cl. H02J 9/06; H02J 7/00; H02J 7/02; H01M 10/06; H01M 10/0525; H01M 10/46

(52) U.S. Cl. CPC H02J 9/06; H02J 7/0063; H02J 7/02; H02J 7/0013; H01M 10/46; H02J 7/00032; H01M 10/06; H01M 10/0525; H02J 7/0048

(57) ABSTRACT

A modular power supply apparatus including a base part and a portable part couplable thereto and detachable from the base part, wherein the portable part comprises an energy storage device or a first energy storage element of the energy storage device and a first output, and the portable part is configured such that the energy storage device or the first energy storage element can supply the first output with an electrical voltage, the base part comprises a grid connection, a switching device or a part of same and a second output, and the energy storage device or the first energy storage element of the energy storage device is electrically connected to the switching device in the event of the portable part having been coupled.

### TECHNICAL FIELD

This disclosure relates to a modular apparatus that supplies power comprising a rechargeable energy storage device, a grid connection for an AC voltage source, a first output and a second output, to each of which external electrical loads are connectable, and comprising a switching device, by which the grid connection can be electrically connected to and disconnected from the second output, and the energy storage device or a first energy storage element of the energy storage device can be electrically connected to and disconnected from the second output.

### BACKGROUND

The supply of power to private households and businesses is not constant in many places. Outages and voltage fluctuations in the electrical grid are problematic for sensitive electrical loads that have to be available for virtually 100% of their operating time. These include, for example, systems from communication and information technology such as servers and routers that are used for data storage or ensure access to the internet.

There are numerous types of power supply apparatus that ensure the availability of electrical energy by an additional grid-independent power source. These apparatuses are fed by an AC voltage source, normally the electrical grid, and comprise as grid-independent power source a rechargeable energy storage device that can be charged by the AC voltage source. In the event of disturbances in the electrical grid, sensitive electronic loads connected thereto can accept alternating current AC or direct current DC. That is to say that energy is provided from the rechargeable energy storage device if the power of the AC voltage source is outside defined limits on account of a disturbance of the electrical grid or the AC voltage source fails completely.

A distinction is drawn here between a general standby power supply, GSS for short, and an uninterruptible power supply, UPS for short. Both types of apparatus offer a power supply for electrical loads in the event of outage of the electrical grid. In contrast to a UPS, a GSS switches over more slowly between the AC voltage source and the energy storage device, and so a momentary voltage drop is possible.

A further example of power supply apparatuses fed by the electrical grid is grid-coupled island installations, that is to say solar installations comprising an energy storage device that can both feed generated current into the public electrical grid and draw alternating current from the electrical grid. External loads can be fed both directly from the battery and with current from the electrical grid.

Such apparatus are very generally provided for stationary use. Normally they are fixedly installed and therefore provided only for local power supply. The energy storage devices used are not usable for other applications. In general, the apparatus cannot be flexibly adapted to individual power requirements.

### SUMMARY

Our modular power supply apparatus includes a) a rechargeable energy storage device having at least one energy storage element, b) a grid connection for an AC voltage source, c) a first output and a second output, to each of which external electrical loads are connectable, and d) a switching device, by which the grid connection can be electrically connected to and disconnected from the second output, the energy storage device or a first energy storage element of the energy storage device can be electrically connected to and disconnected from the second output, and e) a base part and a portable part couplable thereto and detachable from the base part, and wherein the portable part comprises the energy storage device or the first energy storage element of the energy storage device and also the first output, and the portable part is configured to the effect that the energy storage device or the first energy storage element can supply the first output with an electrical voltage, the base part comprises the grid connection, the switching device or a part of same and the second output, and the energy storage device or the first energy storage element of the energy storage device is electrically connected to the switching device in the event of the portable part having been coupled.

### BRIEF DESCRIPTION OF THE DRAWINGS

FIG. 1 schematically shows an example of a modular apparatus comprising a base part and a portable part coupled thereto.

FIG. 2 schematically shows the apparatus illustrated in FIG. 1 with the portable part having been decoupled.

### DETAILED DESCRIPTION

Our apparatus that supplies power is distinguished by the following features:
a. The apparatus has a rechargeable energy storage device having at least one energy storage element.
b. The apparatus has a grid connection for an AC voltage source.
c. The apparatus has a first output and a second output, to each of which external electrical loads are connectable.
d. The apparatus has a switching device, by which:
   the grid connection can be electrically connected to and disconnected from the second output, and
   the energy storage device or a first energy storage element of the energy storage device can be electrically connected to and disconnected from the second output.

In contrast to the apparatus discussed in the Background section, our apparatus is distinguished by the fact that it is of modular construction and has the following features:
e. The apparatus comprises a base part and a portable part that is couplable thereto and detachable from the base part.
f. The portable part comprises the energy storage device or the first energy storage element of the energy storage device and also the first output, wherein the portable part is configured to the effect that the energy storage device or the first energy storage element can supply the first output with an electrical voltage.
g. The base part comprises the grid connection, the switching device or a part of same and the second output.
h. The energy storage device or the first energy storage element of the energy storage device is electrically connected to the switching device in the event of the portable part having been coupled.

The apparatus has components the same as or similar to those of a traditional UPS or an island installation, that is to say that it is able to be operated as a UPS or island installation. However, the components are arranged in modules that are usable independently of one another, the base part and the portable part, which enables more flexible use of the components. In this regard, for example, the portable part always comprises the energy storage device or the first energy storage element of the energy storage device and is thus suitable for supplying power to external electrical loads totally independently of the base part. It can be decoupled from the base part and is also suitable for non-stationary applications. The base part can in turn supply loads attached to the second output with power even if the portable part is decoupled. Furthermore, it is possible, by exchanging the portable part, for example, to adapt the apparatus to individual power requirements, that is to say to equip it, for example, with a more powerful energy storage device.

The components comprised by the base part are generally absolutely necessary for stationary operation—with and without the portable part. In this regard, the grid connection and the switching device or the part of same ensure that the second output is supplied with power if the portable part is decoupled.

Preferred Configurations of Base Part and Portable Part

The base part and the portable part are preferably each enclosed by a housing embodied from plastic and/or metal and optionally having perforations, for instance for the grid connection and the second output. The housing is preferably configured to ensure shielding of optionally contained electronic components for protection of the surroundings. Furthermore, it can be configured for cooling contained components, that is to say have cooling slots or cooling ribs, for example.

The base part and the portable part preferably each have a coupling region that are directly in contact with one another when the portable part is coupled to the base part. The coupling is preferably a mechanical coupling. It optionally comprises a mechanical locking. For this purpose, the coupling region of the base part can be a receptacle, for example, corresponding in its shape and size to the portable part or the coupling region of the portable part and in which the portable part or the coupling region thereof can be arranged, in particular mechanically fixed.

To ensure the electrical connection between the energy storage device or the first energy storage element of the energy storage device and the switching device in the coupled state, the portable part and the base part preferably have a coupling device in respectively complementary fashion. These enable a releasable electrical coupling between the portable part and the base part. In the simplest example, the coupling devices can each be an electrical contact arranged in the coupling regions of base part and portable part. One of the contacts can be, for example, as a plug and the other as a socket corresponding thereto.

Particularly preferably, the base part and the portable part are configured such that the electrical and the mechanical coupling between the portable part and the base part can be established and disconnected in one step. If the coupling region of the base part is a receptacle for this purpose, for example, the electrical contacts can be arranged in the contact regions such that they are directly in contact with one another when the portable part is fixed in the receptacle.

The base part is very generally provided for stationary operation and is therefore preferably permanently fixed in devices or spatial locations provided therefor.

The portable part is preferably dimensioned such that one person can carry it without great effort. It very generally weighs not more than 15 kg.

Preferred Configurations of the Switching Device/UPS Functionality

A UPS functionality of the apparatus can be ensured by the switching device.

For this purpose, the switching device in a first preferred variant as UPS switching element can comprise a changeover switch having a first switch input connected to the grid connection, and a second switch input connected to the energy storage device in the event of the portable part having been coupled. The second output is then attached to the output of the changeover switch.

In a second preferred example, the switching device as UPS switching element can comprise two mutually independently switchable switches, one of which is arranged between the grid connection and the second output and the second of which is arranged between the energy storage device and the second output.

The changeover switch can be, for example, a double-pole double-throw (DPDT) changeover switch or a double-pole changeover switch with a center position (DPCO). It is thereby possible to switch over between the first and second switching inputs and the second output. A center position makes it possible for neither of the two switching inputs to be connected to the second output. In mutually independently switchable switches, there is the possibility of their each being single-pole one-way switches (SPST, SPDT) or on/off/on switches with a stable center position (SPCO, SPTT). By driving the individual switches in a crosswise manner, it is possible to switch over between the two connections in an uninterruptable manner.

The first of the two variants is generally the preferred variant. With the changeover switch, the changeover from the first to the second switching position can be effected in one step. If a plurality of switches are used, the switching device requires a control unit that drives the switches in a synchronized manner.

In both examples, the switching device is preferably configured such that, in a first switching position, the grid connection is connected to the second output. In the event of falling below a power value, for example, an electrical voltage or in the event of complete failure of the power supplied by the grid connection, the switching device switches to a second switching position, in which the energy storage device is connected to the second output. A switchover back to the first switching position can be effected when the disturbance of the grid connection has been rectified.

If the switching device is composed of a plurality of parts, for example, comprises the two mutually independently switchable switches, it may be preferred for one part of the switching device, for instance one of the two switches, to be situated in the base part and a further part of the switching device, for instance the second of the two switches, to be arranged in the portable part. It is generally preferred for all parts of the switching device to be situated in the base part.

Preferred Configurations of the Switching Device/Energy-Optimized Operation

The switching device can also be configured and/or controlled such that it connects the grid connection to the first and/or second output exclusively when at least a power value of the energy storage device and/or a power value of the at least one external electrical load fall(s) below or exceed(s) a predefined limit value.

While traditional UPS apparatus supply connected electrical loads with grid power during normal operation and switch over to supply from an energy storage device only in a disturbance, the priority in this example is exactly the opposite in that it is on the use of energy from the energy storage device.

Preferred Configurations of the Switching Device/Automatic Switchover Upon Decoupling of the Portable Part

The switching device is designed such that upon decoupling of the portable part, the grid connection can be connected to the second output. Loads connected to the base part can thus be operated without the portable part directly and without a safeguard by the energy storage device. In the coupled state, the functions of the portable part and of the base part can complement one another. By way of example, the switching device can connect the energy storage device or the first energy storage element in the portable part to the second output such that the apparatus has the UPS functionality described.

Particularly preferably, the apparatus is configured to the effect that upon decoupling of the portable part, the grid connection is automatically connected to the second output.

It is preferred for the apparatus to be distinguished by at least one of the four directly following additional features a. to d.:
a. The base part comprises a second energy storage element of the energy storage device.
b. The base part is configured such that the second energy storage element can supply the second output and/or a third output in the base part with an electrical voltage.
c. The switching device is configured to establish or disconnect an electrical connection between the second energy storage element and the second output.
d. The grid connection is electrically connected to the second energy storage element such that the latter can be charged by the AC voltage source.

Preferably, the directly aforementioned features a. to c., preferably all of features a. to d., are realized in combination with one another.

In these examples, the apparatus has a UPS functionality even if the portable part is not coupled to the base part.

The energy storage device can comprise exactly one energy storage element, which is then arranged as energy storage device in the portable part. With the second energy storage element, the energy storage device is of at least bipartite construction. It then comprises the first energy storage element in the portable part and the second energy storage element in the base part. Preferably, the apparatus is configured such that the voltages and/or the capacities of the energy storage elements are added together in the event of the portable part having been coupled.

Fundamentally, the energy storage elements can be single cells. Preferably, however, each of the energy storage elements comprises two or more cells interconnected in parallel and/or in series with one another.

It is preferred for the energy storage device to supply overall a voltage of 12 V to 60 volts DC voltage.

The rated capacity of the energy storage element(s) comprised by the energy storage device is generally a maximum of 5 kWh. Preferably, the rated capacity of an individual energy storage element is 200 Wh to 2000 Wh, particularly preferably 500 Wh to 1000 Wh, depending on type and size.

In the European Union, manufacturer indications with respect to indications concerning the rated capacities of secondary electrochemical energy storage devices are strictly regimented. In this regard, for instance, indications with respect to the rated capacity of secondary nickel-cadmium batteries have to be based on measurements in accordance with the standards IEC/EN 61951-1 and IEC/EN 60622, indications with respect to the rated capacity of secondary nickel-metal hydride batteries have to be based on measurements in accordance with the standard IEC/EN 61951-2, indications with respect to the rated capacity of secondary lithium batteries have to be based on measurements in accordance with the standard IEC/EN 61960 and indications with respect to the rated capacity of secondary lead-acid batteries have to be based on measurements in accordance with the standard IEC/EN 61056-1. Any indications with respect to rated capacities herein are preferably likewise based on these standards.

It is preferred for the apparatus to be distinguished by at least one of the five directly following additional features a. to e.:
a. The apparatus comprises a charging connection for an additional external voltage source.
b. The base part comprises the charging connection.
c. The charging connection is electrically connected to the second energy storage element such that the latter can be charged by the additional external voltage source.
d. The portable part comprises the charging connection.
e. The charging connection is electrically connected to the first energy storage element such that the latter can be charged by the additional external voltage source.

Particularly preferably, the directly aforementioned features a. to c. or features a., d. and e. are combined with one another.

It may thus indeed be preferred for both the base part and the portable part to comprise a charging connection.

Further preferably, features a., b. and e. are realized in combination with one another. That means that the first energy storage element in the portable part can be charged by the additional external voltage source via the base part.

Further preferably, features a., b., c. and e. are realized in combination with one another. That means that the first energy storage element in the portable part and the second energy storage element in the base part can be charged by the additional external voltage source.

The additional external voltage source can be either a DC voltage source or an additional AC voltage source, for example, a photovoltaic or wind power installation, in particular a portable photovoltaic or wind power installation. In general, the peak rated power of the connectable installations is a maximum of 0.4 kW. By way of example, the charging connection can be a two-pole 12-volt or 24-volt or 36-volt socket. Very small installations can also be connected to the charging connection by Power over Ethernet (PoE). The charging connection can accordingly also be a socket for an 8P8C plug.

It is also possible for the portable part to have, in addition to the charging connection or as an alternative thereto, a dedicated grid connection for an AC voltage source such as a dedicated grid connection being necessarily comprised by the base part.

Such a grid connection is preferably dimensioned for a connection of an AC voltage source with a voltage of 90 V to 1000 V, which is provided by a power supply facility, for example. The AC voltage source is preferably an AC low-voltage grid with a voltage of 220-240 volts. By way of example, the grid connection can be a two- or three-core cable coupling in accordance with IEC 60320-C13.

Preferably, the energy storage device is a rechargeable storage device for electrical energy on an electrochemical basis.

It is preferred for the apparatus to be distinguished by at least one of the three directly following additional features a. to c.:
a. The first energy storage element comprises as secondary cell at least one rechargeable battery cell of the lithium-ion rechargeable battery type.
b. The second energy storage element comprises as secondary cell at least one rechargeable battery cell of the lead-acid rechargeable battery type.
c. The first energy storage element comprises as secondary cell at least one rechargeable battery cell of the lithium-ion rechargeable battery type and the second energy storage element comprises as secondary cell at least one rechargeable battery cell of the lead-acid rechargeable battery type.

Preferably, the individual energy storage elements are adapted to the respective requirement with regard to the underlying chemical redox system and also their electrical values or their geometric or structural features.

In an example comprising a first energy storage element in the portable part and a second energy storage element in the base part, it may be preferred for the first and second energy storage elements to be different types of energy storage elements. It is possible, for example, for an energy storage element that is particularly suitable for repeated charging and discharging to be installed in the portable part, while the energy storage element in the base part is particularly well suited to staying in a charged state since this element only has to be used in the case of disturbance.

It is preferred for the apparatus to be distinguished by at least one of the three directly following additional features:
a. The apparatus is configured such that the first and second energy storage elements are charged simultaneously by the AC voltage source.
b. The apparatus is configured such that the first and second energy storage elements can be charged simultaneously by the additional external voltage source.
c. The apparatus is configured such that the first and second energy storage elements can be discharged simultaneously.

Particularly preferably, the directly aforementioned features a. to c. are realized in combination with one another.

Simultaneous charging of the first and second energy storage elements requires a charging regulator, which is preferably arranged in the base part. The charging regulator is connected between the respective voltage source and the energy storage elements. However, it may also be preferred for only the portable part to have a charging regulator for the energy storage device or the first energy storage element. In a further example, the first and second energy storage elements are each assigned a separate charging regulator, by way of which the energy storage elements can be respectively charged. The charging regulator for the first energy storage element is then preferably arranged in the portable part, and the charging regulator for the second energy storage element is preferably arranged in the base part.

In examples in which the first and second energy storage elements differ in terms of their type, it may be necessary that the charge regulator must provide different voltages to be able to charge the energy storage elements. Alternatively, of course, it is also possible to use different charging regulators.

To simultaneously charge and discharge the first and second energy storage elements, it is expedient for the first and second energy storage elements to be interconnected in parallel or in series with one another in the event of the portable part having been coupled. Their voltages are added together in an interconnection in series. Larger currents can be provided in an interconnection in parallel.

Preferably, the apparatus comprises a means that makes it possible to regulate charge balancing between the energy storage elements arranged in the base part and in the portable part. This is because if the portable part was used independently of the base part, energy storage elements arranged in the base part and in the portable part very generally have different states of charge.

In the simplest example, the means that regulates charge balancing can be a resistor in parallel with one of the energy storage elements, whereby the voltage of said energy storage element is limited to a specific end-of-charge voltage. Passive balancing of energy storage elements is made possible as a result.

There is furthermore the possibility of, for example, isolation diodes being arranged between the energy storage elements arranged in the base part and in the portable part. The diodes limit potential balancing currents to a direction in which balancing can be effected. For example, only from energy storage elements arranged in the base part in the direction of the energy storage elements arranged in the portable part.

The means that makes it possible to regulate charge balancing between the energy storage elements arranged in the base part and in the portable part can also comprise an active balancing regulator (an electronic circuit that is usually part of a battery management system and ensures a uniform electrical charge distribution of energy storage elements within an energy storage device constructed in a similar manner but are slightly different from an electrical standpoint as a result of manufacturing tolerances and aging). By a balancer circuit, for example, the active balancing regulator can realize charge transfer among energy storage elements and transfer energy from energy storage elements having higher charge to energy storage elements having lower charge or prevent this charge transfer.

Preferably, the energy storage elements of the energy storage device can be dynamically interconnected with one another. For this purpose, the switching device can be configured to connect the energy storage elements in series or in parallel with one another, as required.

It is preferred for the apparatus to be distinguished by at least one of the five directly following additional features a. to e.:
a. The apparatus comprises a control and/or monitoring device.
b. The control and/or monitoring device is designed to detect at least one power value of the grid connection.
c. The control and/or monitoring device is designed to detect a state of charge and/or power value of the energy storage device and/or of individual energy storage elements.
d. The control and/or monitoring device is connected to the switching device and designed to put the switching device or individual switching elements of the switching device into different switching states.
e. The control and/or monitoring device is designed to detect whether there is an electrical and/or mechanical coupling between the base part and the portable part.

Particularly preferably, the directly aforementioned features a. to d., in particular features a. to e., are combined with one another.

In an example in which the portable part has the dedicated grid connection, it is preferred for the control and/or monitoring device to be designed to monitor said grid connection, too, with regard to deviations of power values.

Furthermore, it may be preferred for the control and/or monitoring device to be configured to:
detect at least one power value of the charging connection(s), and/or
detect at least one power value of an electrical load at the first output and/or at the second output, optionally also at further outputs, and/or
detect switching states of the switching device or of individual switching elements of the switching device, for example with the aid of sensors, and/or
put the switching device or individual switching elements of the switching device into different switching states, for example with the aid of actuators and/or signal generators.

The control and/or monitoring device can comprise a plurality of components. For example, it can comprise a voltmeter that detects a power value or a large-scale integrated electronic component (known as: integrated circuit, IC) such as a microcontroller for processing data.

The microcontroller can, for example, be connected to the switching device or individual switching elements of the switching device and control the switching behavior thereof depending on a power value determined. This can involve, in particular, a power value from the group comprising temperature, voltage, state of charge, charging current.

There is the possibility of the control and/or monitoring device together with the switching device or individual switching elements of the switching device being parts of a large-scale integrated electronic component (the control and/or monitoring device being integrated into the switching device, or of the switching device or individual switching elements of the switching device being integrated into the control and/or monitoring device.

The control and/or monitoring device can comprise a plurality of subunits. For example, a first subunit of the control and monitoring device can be arranged in the base part and a second subunit of the control and monitoring device can be arranged in the portable part.

It is preferred for the apparatus to be distinguished by at least one of the two directly following additional features, by both features in some preferred examples:
a. The base part has a display and/or operating unit.
b. The portable part has a display and/or operating unit.

In the simplest example, such a display and/or operating unit can be a plurality of LEDs. The latter can provide information about various operating states of the apparatus, for example, in an apparatus having UPS functionality whether there is a disturbance of the grid connection and what the state of charge of the energy storage device is. It is preferred for the display and/or operating unit to comprise a display on which said operating states and/or power values of the energy storage device and/or states of the switching device and/or of the control and/or monitoring device can be displayed. The display can be a TFT or LCD display, for example.

Preferably, different states of the switching device can be manually activated and deactivated by way of the display and/or operating unit.

It is preferred for the apparatus to be distinguished by at least one of the five directly following additional features a. to e.:
a. The apparatus comprises a data transfer unit connected to the control and/or monitoring device.
b. The apparatus comprises a data input provided for non-wireless transfer of data and/or switching signals from and/or to the data transfer unit.
c. The data transfer unit is configured to receive data and/or switching signals wirelessly from an external transmitter and/or to transfer them wirelessly to an external receiver.
d. The data transfer unit is configured to forward the data and/or switching signals received from the external transmitter to the control and/or monitoring device.
e. The data transfer unit is configured to forward data about switching states and/or power values of the energy storage device and/or power values of the at least one external electrical load to the external receiver.

Particularly preferably, all of the directly aforementioned features a. to e. are realized in combination with one another.

The data transfer unit can be configured to transfer the data and/or signals via a wired data network (LAN) or wirelessly with the aid of modulated electromagnetic waves in the radio-frequency range. In this regard, the data transfer unit can be a Bluetooth, WLAN, Zigbee, GSM, CDMA, UMTS or LTE chip, for example. The external receiver and/or the external transmitter can be, for example, a data processing apparatus such as a computer or cellular phone. The data transfer unit can be present as a separate component or else be integrated, for example, into the control and/or monitoring unit.

It is preferred for the apparatus to be distinguished by at least one of the two directly following additional features a. and b.:
a. The apparatus comprises a detection means to detect mechanical coupling and/or decoupling of the portable part and to report that to the control and/or monitoring device.
b. The apparatus comprises a mechanical locking means for securing the portable part to the base part.

Since, upon decoupling of the portable part, energy storage elements arranged in the portable part are no longer available to supply power to the second output, for an uninterruptible power supply the switching device may need to switch back to supply via the grid power. The detection means can support the abovementioned automatic connection of the second output to the grid connection.

The detection means is preferably configured to monitor the status of the apparatus and to report a change of status, namely the coupling or decoupling of the portable part, to the control and/or monitoring device.

In the simplest example, the detection means detects the voltage drop which, upon decoupling, results from the electrical disconnection of the energy storage element(s) arranged in the portable part. In this case, the detection means is preferably part of the control and/or monitoring device described above.

In alternative examples, the detection means can be arranged in the coupling region in which, in the coupled state, the portable part and the base part are directly in contact with one another.

If, during a decoupling of the portable part, for example, AC loads are fed current from the first energy storage element of the energy storage device via an inverter, in the event of a switchover to grid power the control and/or monitoring device very generally has to carry out a synchronization of the AC voltage sources. In the event of a changeover of a voltage source, parameters from the group comprising voltage, frequency and phase angle have to be adapted to one another.

The outputs of the apparatus can be used for the connection of electrical loads, wherein the latter can be AC (alternating current) and/or DC (direct current) loads. It may be preferred for the apparatus to comprise at least one inverter which converts DC voltage from the at least one energy storage element into an alternating current. For an example in which the apparatus is configured for DC loads, it may be preferred for the apparatus to comprise at least one DC-DC converter which converts a DC voltage fed from the energy storage element into a DC voltage having a higher, lower or inverted voltage level.

Preferably, the apparatus is distinguished by at least one of the two directly following additional features a. and b.:
a. At least one output of the apparatus is an AC voltage output to which external AC voltage loads are connectable.
b. The apparatus comprises at least one inverter connected between the energy storage device and the AC voltage output.

Particularly preferably, the second output is an AC voltage output.

Preferably, the apparatus is distinguished by at least one of the three directly following additional features a. to c.:
a. At least one output of the apparatus is a DC voltage output to which external DC voltage loads are connectable.
b. The apparatus has a DC-DC converter connected between the energy storage device and the DC voltage output.
c. The portable part comprises the DC voltage output.

Preferably, the directly aforementioned features a. and c. or a. to c. are realized in combination with one another.

In one preferred example, the energy storage device or the first energy storage element of the energy storage device in the portable part can also be charged via the first output. The first output is thus configurable as an input, in principle.

The modular configuration of the apparatus enables in particular a flexible use of the energy storage device or of the first energy storage element of the energy storage device in the portable part. The portable part is usable for diverse mobile purposes. By way of example, the portable part can serve as a mobile energy source to supply power to a caravan. The portable part can also be configured as a rechargeable battery for e-bikes or other apparatuses or means of transport provided with an electric motor.

Preferably, the apparatus is distinguished by at least one of the three directly following additional features a. to c.:
a. The portable part has an illuminant coupled to the energy storage device.
b. The illuminant can be switched by way of the control and/or monitoring device.
c. The illuminant can be switched by way of a separate light switch.

Preferably, the directly aforementioned features a. and b. or a. and c. are realized in combination with one another. Particularly preferably, all three features a. to c. can also be realized in combination with one another.

The illuminant can be very useful during camping, for example. Preferably, the illuminant can be controlled by way of the display and/or operating unit already described.

Further advantages and aspects of our modular power supply apparatus are evident from the claims, the following description of a preferred example and with reference to the drawings.

Electrical connections are merely illustrated symbolically in the figures. Each of the connections illustrated comprises, in practice, the respectively required number of electrical conductors, generally two conductors.

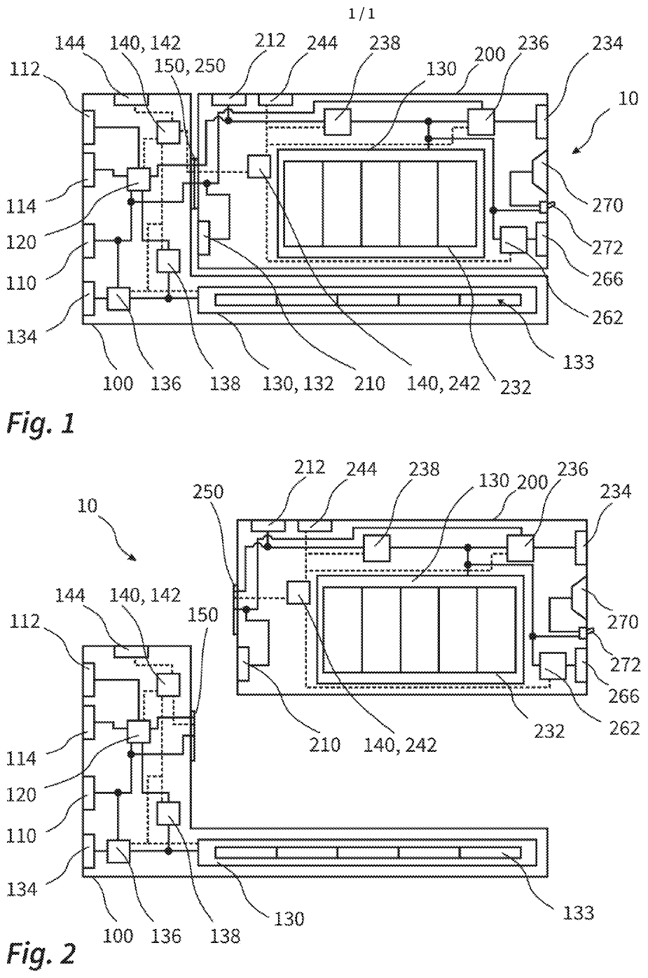

The apparatus 10 in accordance with FIGS. 1 and 2 comprises a base part 100 and a portable part 200, which is couplable thereto. The portable part 200 is shown in the coupled state in FIG. 1, and in the decoupled state in FIG. 2.

The base part 100 and the portable part 200 each have a coupling region with the coupling devices 150 and 250 embodied complementarily to one another. When the portable part 200 is coupled to the base part 100, the coupling devices 150 and 250 are directly in contact with one another. The coupling comprises both a mechanical coupling and an electrical coupling between the base part 100 and the portable part 200.

The coupling devices 150 and 250 very generally comprise a mechanical locking means (not illustrated) which prevents inadvertent decoupling of the portable part 200 from the base part 100.

The apparatus 10 comprises an energy storage device 130. The latter is composed of five energy storage elements in the portable part 200, including the energy storage element 232, and a further five energy storage elements in the base part 100, including the energy storage element 133. The energy storage elements in the base part 100 are rechargeable lead-acid rechargeable battery cells. The energy storage elements in the portable part 200 are rechargeable lithium-ion cells.

The apparatus 10 has a total of four outputs that can serve for supplying power to electrical loads, namely the first output 212, the second output 112, the third output 114 and the fourth output 266.

Both the base part 100 and the portable part 200 have a grid connection for an AC voltage source, these being the connections 110 and 210. AC voltage can be fed into the apparatus via these connections. The connections 110 and 210 are respectively coupled via a charging regulator, the charging regulators 136 and 236, to the energy storage device 130 or the energy storage elements respectively arranged in the base part 100 and the portable part 200. The energy storage device 130 can thus be charged via the connections 110 and 210.

Furthermore, the apparatus 10 comprises, both at the base part 100 and at the portable part 200, a charging connection 134, 234 for an additional DC or AC voltage source, in particular for voltage from a photovoltaic or wind power installation. The energy storage device 130 can also be charged via these connections. In this example, the energy storage elements arranged in the base part 100 are charged via the charging regulator 136, wherein the latter is configured such that, in the coupled state, in addition to the energy storage elements in the base part 100, the charging regulator can simultaneously also charge the energy storage elements in the portable part 200. The charging of the energy storage elements arranged in the portable part 200 with voltage from the grid connection 210 or the charging connection 234 can be effected via the charging regulator 236. In the decoupled state, there is actually no other possible way of doing this.

The portable part 200 comprises the first output 212 and the fourth output 266 that can be supplied with an electrical voltage by the energy storage device 130. The base part 100 comprises the second output 112 and the third output 114.

The first output 212 is provided for AC loads. For this purpose, the portable part 200 comprises an inverter 238 arranged between the first output 212 and the energy storage device 130 or the five energy storage elements of the energy storage device 130 situated in the portable part 200. The fourth output 266 is a USB charging connection, that is to say that it is used for DC loads. Alternatively, the output 266 could also be a cigarette lighter connection or any other 12 V connection with adapter or the like. A DC-DC converter 262 is arranged between the fourth output 266 and the energy storage device 130 and adapts a DC voltage supplied by the energy storage device 130 to a required value, here 5 V, for example.

The apparatus 10 has a switching device 120, by which the grid connection 110 can be electrically connected to and disconnected from the second output 112. The switching device 120 is arranged in the base part 100. The second output 112 can thus be connected as an AC voltage output by way of the switching device 120.

In the event of the portable part 200 having been coupled, the energy storage elements of the energy storage device 130 arranged in the portable part 200 are electrically connected to the switching device 120 via the coupling devices 150 and 250. The energy storage elements of the energy storage device 130 arranged in the portable part 200 can thus also serve for supplying electrical outputs in the base part 100, for instance the third output 114 or the second output 112. At the same time, the energy storage elements of the energy storage device 130 arranged in the base part 100 can also be connected to the output 112 and 114 via the switching device 120. The base part 100 comprises an inverter 138 in order that the DC voltage supplied by the energy storage elements of the energy storage device 130 arranged in the base part 100 can be converted into AC voltage.

The switching device 120 is furthermore configured to interconnect the energy storage elements arranged in the base part 100 and those arranged in the portable part 200 in parallel and/or in series with one another. As a result, the energy storage elements can all be charged and discharged simultaneously. In particular, the energy storage elements arranged in the portable part 200 can thus also be charged via the grid connection 110 for example. The switching device 120 is furthermore configured such that the third output 114 is able to be switched on and/or off separately from the second output 112.

When the energy storage elements arranged in the base part 100 and those arranged in the portable part 200 are interconnected in parallel and/or in series, charge balancing between the energy storage elements arranged in the base part 100 and those arranged in the portable part 200 may be necessary. Such charge balancing may result in a momentary balancing current of a plurality of amperes. To prevent such balancing currents, isolation diodes, for example, can be arranged between the energy storage elements arranged in the base part 100 and those arranged in the portable part 200. Furthermore, configurations are also possible in which the apparatus comprises a balancing regulator (an electronic circuit which is usually part of a battery management system and which ensures a uniform electrical charge distribution of energy storage elements within an energy storage device which are of similar construction but are slightly different from an electrical standpoint owing to manufacturing tolerances and aging). The balancing regulator can both passively and actively maintain or balance different states of charge of the energy storage elements.

The apparatus also has a control and/or monitoring device 140 in addition to the switching device 120. The control and/or monitoring device comprises a control and/or monitoring unit 142 in the base part 100 and a control and/or monitoring unit 242 in the portable part 200. The control and/or monitoring unit 142 is designed such that it can detect the present voltage and the state of charge of the energy storage elements arranged in the base part 100. It can furthermore also detect the status of the grid connection 110. The control and/or monitoring unit 242 is designed such that it can detect the present voltage and the state of charge of the energy storage elements arranged in the portable part 200. It can furthermore also detect the status of the grid connection 210.

The control and/or monitoring device 140 is additionally designed to put the switching device 120 or individual switching elements of the switching device into different switching states or to provide corresponding switching signals.

The control and/or monitoring device 140 comprises a data transfer unit configured to receive switching signals wirelessly from an external transmitter (not shown) and/or to transfer them wirelessly to an external receiver (not shown). Moreover, the data transfer unit is configured to forward data about switching states and power values of the energy storage device 130 and power values of connectable external electrical loads to the external receiver (not shown).

The control and/or monitoring device 140 is configured such that, in a deviation of a power value at the grid connection 110, i.e., for example, a disturbance in the electrical grid, the control and/or monitoring device can drive the switching device 120 or individual switching elements of same in such a way that electronic loads connected to the second output 112 are supplied with energy from the energy storage device 130.

The control and/or monitoring device 140 additionally detects whether there is an electrical and mechanical coupling between the base part 100 and the portable part 200. For this purpose, the control and/or monitoring device 140 can measure a voltage drop, for example, which upon decoupling of the portable part 200, results from the electrical disconnection of the energy storage elements arranged in the portable part 200.

The base part 100 and the portable part 200 respectively comprise a display and operating unit 144, 244. These display and operating units 144, 244 are configured as TFT displays and provide information about present operating states. They are configured as an input apparatus by way of a touch-sensitive surface, and different states of the switching device 120 are manually activated and deactivated by way of this.

In this example, the portable part 200 has an illuminant 270 that is fed electrical energy by the energy storage elements arranged in the portable part 200. The illuminant 270 is switchable via a separate light switch 272. Furthermore, the illuminant 270 can also be switched via the control and/or monitoring device 140.

1-12. (canceled)

13. A modular power supply apparatus comprising:
a. a rechargeable energy storage device having at least one energy storage element,
b. a grid connection for an AC voltage source,
c. a first output and a second output, to each of which external electrical loads are connectable, and
d. a switching device, by which
the grid connection can be electrically connected to and disconnected from the second output,
the energy storage device or a first energy storage element of the energy storage device can be electrically connected to and disconnected from the second output, and
e. a base part and a portable part couplable thereto and detachable from the base part, and wherein
the portable part comprises the energy storage device or the first energy storage element of the energy storage device and also the first output, and the portable part is configured to the effect that the energy storage device or the first energy storage element can supply the first output with an electrical voltage,
the base part comprises the grid connection, the switching device or a part of same and the second output, and
the energy storage device or the first energy storage element of the energy storage device is electrically connected to the switching device in the event of the portable part having been coupled.

14. The apparatus as claimed in claim 13, wherein at least one of:
a. the base part comprises a second energy storage element of the energy storage device,
b. the base part is configured such that the second energy storage element can supply the second output and/or a third output in the base part with an electrical voltage,
c. the switching device is configured to establish or disconnect an electrical connection between the second energy storage element and the second output, and
d. the grid connection is electrically connected to the second energy storage element such that the latter can be charged by the AC voltage source.

15. The apparatus as claimed in claim 13, wherein at least one of:
a. the apparatus further comprises a charging connection for an additional external voltage source,
b. the base part comprises the charging connection,
c. the charging connection is electrically connected to the second energy storage element such that the latter can be charged by the additional external voltage source,
d. the portable part comprises the charging connection, and
e. the charging connection is electrically connected to the first energy storage element such that the latter can be charged by the additional external voltage source.

16. The apparatus as claimed in claim 13, wherein at least one of:
a. the first energy storage element comprises as secondary cell at least one rechargeable battery cell of the lithium-ion rechargeable battery type,
b. the second energy storage element comprises as secondary cell at least one rechargeable battery cell of the lead-acid rechargeable battery type, and
c. the first energy storage element comprises as secondary cell at least one rechargeable battery cell of the lithium-ion rechargeable battery type and the second energy storage element comprises as secondary cell at least one rechargeable battery cell of the lead-acid rechargeable battery type.

17. The apparatus as claimed in claim 13, wherein at least one of:
a. configured such that the first and second energy storage elements are charged simultaneously by the AC voltage source,
b. configured such that the first and second energy storage elements can be charged simultaneously by the additional external voltage source, and
c. configured such that the first and second energy storage elements can be discharged simultaneously.

18. The apparatus as claimed in claim 13, wherein at least one of:
a. the apparatus further comprises a control and/or monitoring device,
b. the control and/or monitoring device detects at least one power value of the grid connection,
c. the control and/or monitoring device detects a state of charge and/or power value of the energy storage device and/or of individual energy storage elements,
d. the control and/or monitoring device is connected to the switching device and puts the switching device or individual switching elements of the switching device into different switching states, and
e. the control and/or monitoring device detects whether there is an electrical and/or mechanical coupling between the base part and the portable part.

19. The apparatus as claimed in claim 13, wherein at least one of:
a. the base part has a display and/or operating unit, and
b. the portable part has a display and/or operating unit.

20. The apparatus as claimed in claim 13, wherein at least one of:
a. the apparatus further comprises a data transfer unit connected to the control and/or monitoring device,
b. the apparatus further comprises a data input provided for non-wireless transfer of data and/or switching signals from and/or to the data transfer unit,
c. the data transfer unit is configured to receive data and/or switching signals wirelessly from an external transmitter and/or to transfer them wirelessly to an external receiver,
d. the data transfer unit is configured to forward the data and/or switching signals received from the external transmitter to the control and/or monitoring device, and
e. the data transfer unit is configured to forward data about switching states and/or power values of the energy storage device and/or power values of the at least one external electrical load to the external receiver.

21. The apparatus as claimed in claim 13, wherein at least one of:
a. the apparatus further comprises a detection means that detects mechanical coupling and/or decoupling of the portable part and reports that to the control and/or monitoring device, and
b. the apparatus further comprises a mechanical locking means that secures the portable part to the base part.

22. The apparatus as claimed in claim 13, wherein at least one of:
a. at least one output is an AC voltage output to which external AC voltage loads are connectable, and
b. the apparatus further comprises at least one inverter connected between the energy storage device and the AC voltage output.

23. The apparatus as claimed in claim 13, wherein at least one of:
a. at least one output is a DC voltage output to which external DC voltage loads are connectable,
b. the apparatus further comprises a DC-DC converter connected between the energy storage device and the DC voltage output, and
c. the portable part comprises the DC voltage output.

24. The apparatus as claimed in claim 13, wherein at least one of:
a. the portable part has an illuminant coupled to the energy storage device,
b. the illuminant can be switched by the control and/or monitoring device, and
c. the illuminant can be switched by a separate light switch.
